(19) United States
(12) Patent Application Publication
(10) Pub. No.: US 2025/0270796 A1
(43) Pub. Date: Aug. 28, 2025

(54) DISPLAY SYSTEM FOR WORK MACHINE, WORK MACHINE, AND DISPLAY METHOD FOR WORK MACHINE

(71) Applicant: Komatsu Ltd., Tokyo (JP)

(72) Inventors: Shun Murakami, Tokyo (JP); Ryosuke Koga, Tokyo (JP); Takehiro Shibata, Tokyo (JP); Yuki Takahashi, Tokyo (JP)

(73) Assignee: Komatsu Ltd., Tokyo (JP)

(21) Appl. No.: 18/858,915

(22) PCT Filed: Aug. 28, 2023
(86) PCT No.: PCT/JP2023/030935

§ 371 Date: Oct. 22, 2024

(30) Foreign Application Priority Data
Sep. 15, 2022 (JP) 2022-147097

(51) Int. Cl. E02F 9/26; B60R 1/27

(52) U.S. Cl. CPC E02F 9/267; B60R 1/27; B60R 2300/303; B60R 2300/306; B60R 2300/607; B60R 2300/70

(57) ABSTRACT

A display system for a work machine includes: a display unit that displays a camera image obtained by photographing around an excavator; a display unit controller that causes the display unit to display the camera image; and a message window image generation unit that when a predetermined event related to the excavator occurs, generates a message window image indicating a content of the event, the display unit controller, when a predetermined event related to the excavator occurs, causing a message window image indicating a content of the event to be displayed in a camera image area for displaying a camera image, and causing the camera image to be displayed in a reduced manner.

### FIELD

The present disclosure relates to a display system for a work machine, a work machine, and a display method for a work machine.

### BACKGROUND

As disclosed in Patent Literature 1, a work machine such as a shovel includes a display unit provided in an operating room, the display unit displaying information related to the work machine such as an engine water temperature, a fuel remaining amount, an operating time, and the like, and displaying an image around the work machine.

### CITATION LIST

### Patent Literature

Patent Literature 1: JP 2021-042638 A

### SUMMARY

### Technical Problem

When various events related to a work machine occur, a message related to the event may be displayed as a message window. A display area of a display unit is limited. When the message window is displayed in a superimposed manner in an area where a camera image is displayed, a display content of the camera image is hidden by a message window image. As a result, there is a possibility that information is not appropriately transmitted to an operator.

### Solution to Problem

In order to achieve an aspect of the present invention, a display system for a work machine, comprises: a display unit that displays a camera image obtained by photographing around a work machine; a display control unit that causes a display unit to display the camera image; and a message window image generation unit that when a predetermined event related to the work machine occurs, generates a message window image indicating a content of the event, wherein when a predetermined event related to the work machine occurs, the display control unit causes a message window image indicating a content of the event to be displayed in a camera image area for displaying the camera image, and causes the camera image to be displayed in a reduced manner.

In order to achieve another aspect of the present invention, a work machine comprises: the display system for a work machine; and working equipment.

In order to achieve still another aspect of the present invention, a display method for a work machine comprises: when a predetermined event related to a work machine occurs, generating a message window image to be displayed in a camera image area displaying a camera image obtained by photographing around the work machine; and causing the camera image to be displayed, and reducing the camera image when the message window image is displayed in the camera image area.

### Advantageous Effects of Invention

According to the present disclosure, when a message window is displayed in an area displaying a camera image around a work machine, the image can be appropriately displayed.

### BRIEF DESCRIPTION OF DRAWINGS

FIG. 1 is a block diagram illustrating a display system of a work machine according to an embodiment.

FIG. 2 is a view illustrating an example of a display example of a display unit.

FIG. 3 is a view illustrating another example of the display example of the display unit.

FIG. 4 is a view illustrating a further example of the display example of the display unit.

FIG. 5 is a view illustrating an example of a display example of a single camera image displayed on the display unit.

FIG. 6 is a view illustrating another example of the display example of the single camera image displayed on the display unit.

FIG. 7 is a flowchart showing a display method for a work machine according to the embodiment.

FIG. 8 is a block diagram illustrating a computer system according to the embodiment.

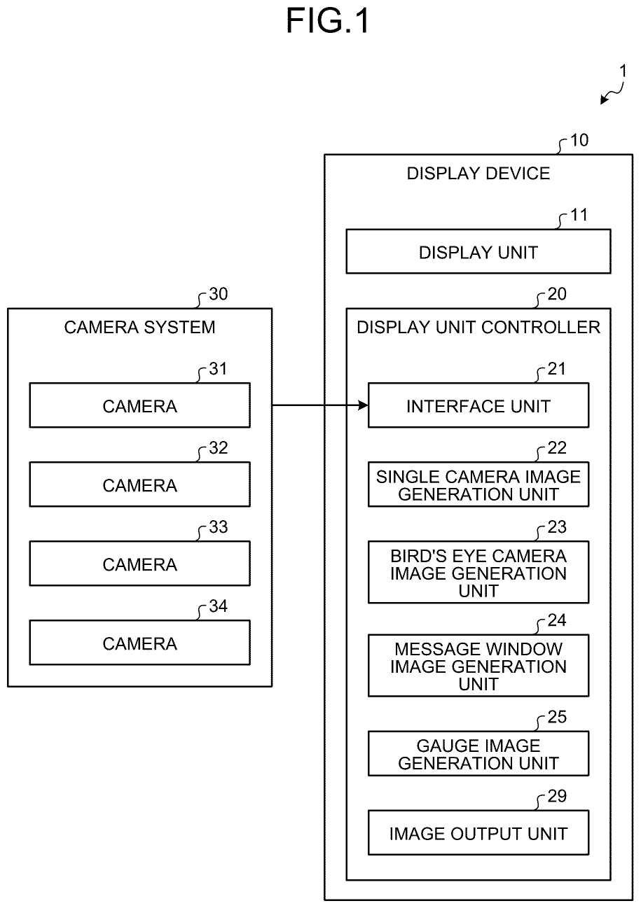

### DESCRIPTION OF EMBODIMENTS

In the following, although embodiments according to the present disclosure will be described with reference to the drawings, the present disclosure is not limited thereto. Components of the embodiments described below can be appropriately combined. In addition, some components may not be used.

### EMBODIMENTS

### Display System for Work Machine

In the embodiment, a case where a work machine is an excavator will be described as an example. The excavator includes working equipment, and a display system 1 for a work machine. The display system 1 for a work machine includes a display device 10 and a camera system 30.

The camera system 30 photographs around the excavator. The camera system 30 is provided in an upper swing body of the excavator. The camera system 30 acquires an image of an imaging target. The camera system 30 functions as a detection unit that detects an object including a person or a work machine such as other excavator present around the excavator. A plurality of the camera systems 30 are disposed around the excavator. In the embodiment, the camera system 30 includes a camera 31, a camera 32, a camera 33, and a camera 34.

The camera 31 is, for example, a rear camera provided at a rear part of an upper swing body 3. The camera 31 images a rear area of the upper swing body 3. The camera 32 is, for example, a right rear camera provided on a right part of the upper swing body 3. The camera 32 images a right rear area of the upper swing body 3. The camera 33 is, for example, a right front camera provided on the right part of the upper swing body 3. The camera 33 images a right front area of the upper swing body 3. The camera 34 is, for example, a left rear camera provided on a left part of the upper swing body 3. The camera 34 images a left rear area of the upper swing body 3. Each of the camera 31, the camera 32, the camera 33, and the camera 34 includes an optical system and an image sensor. The image sensor includes a couple charged device (CCD) image sensor or a complementary metal oxide semiconductor (CMOS) image sensor.

Note that although the camera 34 images a range of a left side area and the left rear area of the upper swing body 3, the camera may image either one of them. Similarly, although the camera 32 images a range of a right side area and the right rear area of the upper swing body 3, the camera may image either one of them. Similarly, although the camera 33 images a range of the right front area and the right side area of the upper swing body 3, the camera may image either one of them. In addition, although the camera system 30 images the left rear, the rear side, the right rear, and the right front of the upper swing body 3, the camera is not limited thereto.

Display Device

The display device 10 is a monitor that displays an image around the work machine. The display device 10 is, for example, a monitor for monitoring surroundings. The display device 10 includes a display unit 11 and a display unit controller 20 which is a display control unit. The display unit controller 20 may be a controller separated from the display device 10.

The display unit 11 displays a camera image or the like obtained by photographing around the excavator. The display unit 11 includes a flat panel display such as a liquid crystal display or an organic electro luminescence (EL) display. The display unit 11 may be a touch panel type.

The camera image includes either one or both of a bird's eye camera image 101 and a single camera image 102 around the excavator. In the embodiment, the camera images are the bird's eye camera image 101 and the single camera image 102 around the excavator.

The bird's eye camera image 101 is an image generated by converting a plurality of image data acquired by each camera of the camera system 30 into an upper viewpoint of the excavator and combining them. In the bird's eye camera image 101, an image of the excavator viewed from above is displayed at the center.

The single camera image 102 is an image of a part of the surroundings of the excavator acquired by one camera of the camera system 30. The single camera image 102 includes at least one of a rear single camera image indicating a rear situation of the excavator acquired by the camera 31, a right rear single camera image indicating a right rear situation of the excavator acquired by the camera 32, a right front single camera image indicating a right front situation of the excavator acquired by the camera 33, and a left rear single camera image indicating a left rear situation of the excavator acquired by the camera 34.

### Display Unit Controller

The display unit controller 20 includes a computer system. The display unit controller 20 includes an interface unit 21, a single camera image generation unit 22, a bird's eye camera image generation unit 23, a message window image generation unit 24, a gauge image generation unit 25, and an image output unit 29.

The interface unit 21 communicates with other hardware included in the excavator. In the embodiment, the interface unit 21 acquires image data from the camera system 30. The interface unit 21 is connected to each of the camera 31, the camera 32, the camera 33, and the camera 34 of the camera system 30. In the embodiment, the interface unit 21 acquires image data indicating the rear situation of the excavator from the camera 31. The interface unit 21 acquires image data indicating the right rear situation of the excavator from the camera 32. The interface unit 21 acquires image data indicating the right front situation of the excavator from the camera 33. The interface unit 21 acquires image data indicating the left rear situation of the excavator from the camera 34.

The interface unit 21 acquires information indicating detection of an abnormality of the work machine from a controller of the work machine. The interface unit 21 acquires information indicating occurrence of an event from the controller of the work machine. The interface unit 21 acquires information indicating an engine water temperature, a fuel remaining amount, an operating time, and the like from the controller of the work machine.

The single camera image generation unit 22 generates the single camera image 102 indicating a situation around the excavator on the basis of the image data acquired by the interface unit 21. More specifically, the single camera image generation unit 22 generates the single camera image 102 on the basis of image data acquired by one camera of the camera system 30.

The bird's eye camera image generation unit 23 generates the bird's eye camera image 101 indicating the situation around the excavator on the basis of the image data acquired by the interface unit 21. More specifically, the bird's eye camera image generation unit 23 generates the bird's eye camera image 101 around the excavator on the basis of the image data acquired by each camera of the camera system 30. The bird's eye camera image generation unit 23 converts the image data acquired by each of the camera 31, the camera 32, the camera 33, and the camera 34 into an upper viewpoint image viewed from a virtual viewpoint above the excavator. The bird's eye camera image generation unit 23 cuts out a part corresponding to a frame area for displaying the bird's eye camera image 101 from each of the upper viewpoint images. The bird's eye camera image generation unit 23 combines the upper viewpoint images to generate the bird's eye camera image 101 around the excavator.

When a predetermined event related to the excavator occurs, the message window image generation unit 24 generates a message window image 104 to be displayed in a camera image area displaying a camera image obtained by photographing around the excavator.

The message window image 104 is, for example, a content indicating guidance to an operator. The message window image 104 is, for example, a content indicating an abnormality of the excavator.

The gauge image generation unit 25 generates an image indicating gauge information indicating a state of the excavator. More specifically, the gauge image generation unit 25 generates a gauge image 103 indicating the gauge information indicating the state of the excavator in an area of the single camera image 102 according to an instruction of the operator, the area displaying the single camera image 102.

The gauge image 103 is an image indicating the gauge information indicating the state of the excavator. The gauge image 103 is, for example, an image of a gauge indicating the engine water temperature, the fuel remaining amount, the operating time, and the like.

The image output unit 29 causes the display unit 11 to display display data indicating the situation around the excavator. The display data includes the camera image, the message window image 104, and the gauge image 103. In the embodiment, the image output unit 29 causes the display unit 11 to display at least the bird's eye camera image 101 and the single camera image 102 around the excavator.

The image output unit 29 causes the display unit 11 to display the camera image obtained by photographing around the excavator. In a case where a message window is displayed in the camera image area of the display unit 11, the image output unit 29 causes the display unit 11 to display the camera image in a reduced manner.

In the embodiment, the image output unit 29 may decide a reduction ratio of the camera image in accordance with an area on a screen of the message window image 104 displayed on the display unit 11. The image output unit 29 causes the display unit 11 to display a camera image reduced to the same shape and size as an area excluding an area in which the message window image 104 is displayed from an area in which the camera image is displayed in a state where the message window image 104 is not displayed.

In the embodiment, in a case where the message window is displayed in the camera image area, the image output unit 29 may cause the display unit 11 to display the single camera image 102 in a reduced manner. More specifically, when the message window is displayed in the area of the single camera image 102, the image output unit 29 may cause the display unit 11 to display the single camera image 102 in a reduced manner.

In the embodiment, when the message window or the gauge information is displayed in the camera image area, the image output unit 29 may cause the display unit 11 to display the single camera image 102 in a reduced manner. More specifically, in a case where the message window or the gauge information is displayed in the area of the single camera image 102, the image output unit 29 may cause the display unit 11 to display the single camera image 102 in a reduced manner.

In the embodiment, in a case where the message window image 104 has the content indicating guidance to the operator, the image output unit 29 may cause the display unit 11 to release the reduction of the single camera image 102 and display the single camera image after a predetermined period elapses after the displaying of the message window image 104.

In the embodiment, in a case where the message window image 104 has the content indicating an abnormality of the excavator, the image output unit 29 may cause the display unit 11 to stop the display of the message window image 104, release the reduction of the single camera image 102, and display the image when the abnormality is resolved.

When a predetermined event related to the excavator occurs, the image output unit 29 causes the message window image 104 to be displayed in the camera image area where the surroundings of the excavator are photographed.

The predetermined event related to the excavator is, for example, detection of various abnormalities of the excavator or detection of a state requiring guidance to the operator.

The image output unit 29 causes the gauge image 103 indicating the gauge information indicating the state of the excavator to be displayed in the area of the single camera image 102 according to the instruction of the operator.

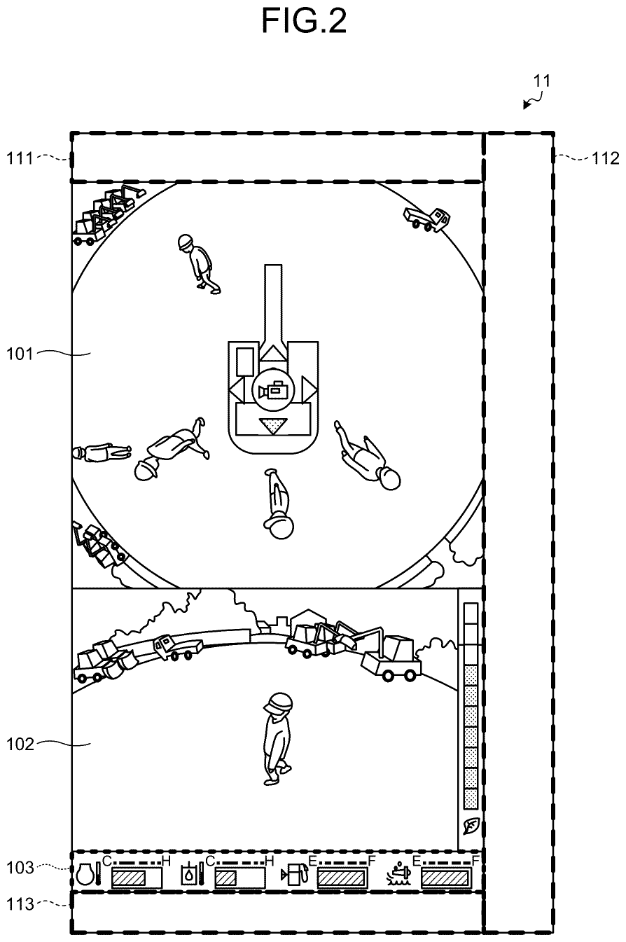

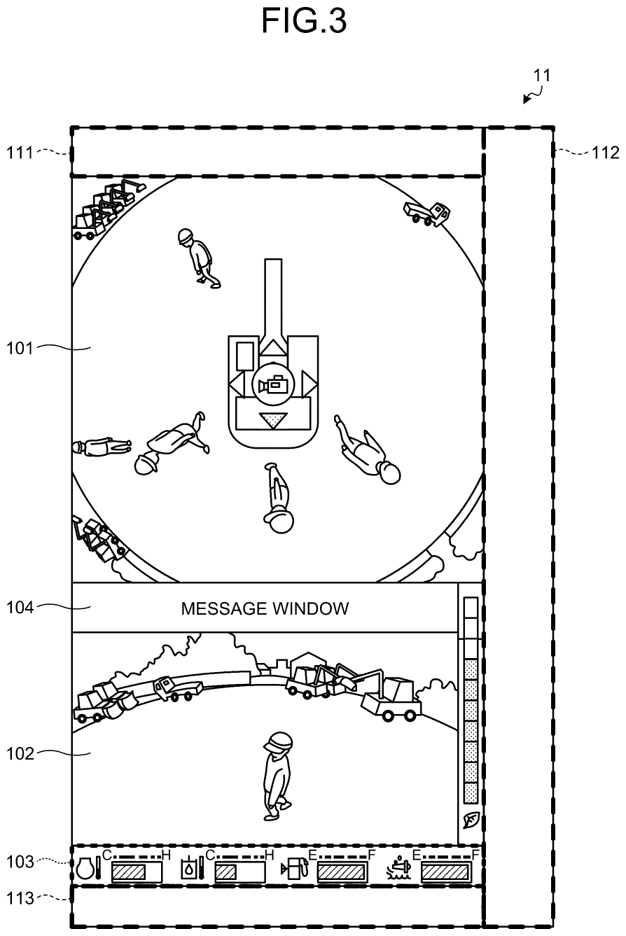

FIG. 2 is a view illustrating an example of a display example of the display unit. FIG. 2 is an example of display on the display unit 11 in a normal state where the message window image 104 (see FIG. 3) is not displayed. In the example illustrated in FIG. 2, the display unit 11 displays the bird's eye camera image 101, the single camera image 102, the gauge image 103, an upper image 111, a side image 112, and a lower image 113. In the upper image 111, the side image 112, and the lower image 113, information indicating an operating state of the excavator and the like are displayed as icon images and the like.

FIG. 3 is a view illustrating another example of the display example of the display unit. In the example illustrated in FIG. 3, the message window image 104 is displayed above an area where the single camera image 102 is displayed in FIG. 2. The single camera image 102 is displayed in a reduced manner. As illustrated in FIG. 2, the single camera image 102 is reduced in accordance with an area excluding the area in which the message window image 104 illustrated in FIG. 3 is displayed from an area in which the single camera image 102 is displayed in a state where the message window image 104 is not displayed.

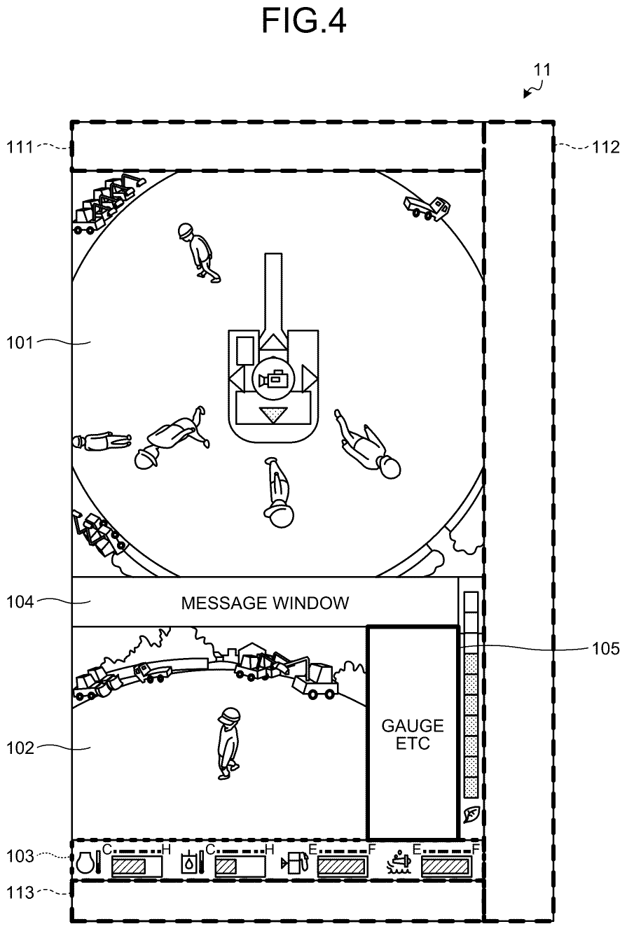

FIG. 4 is a view illustrating a further example of the display example of the display unit. In the example illustrated in FIG. 4, a gauge image 105 is displayed in a right side part of the area where the single camera image 102 is displayed in FIG. 2. The single camera image 102 is displayed in a reduced manner. As illustrated in FIG. 2, the single camera image 102 is reduced in accordance with an area excluding an area in which the gauge image 105 illustrated in FIG. 4 is displayed from an area in which the single camera image 102 is displayed in a state where the gauge image 105 is not displayed.

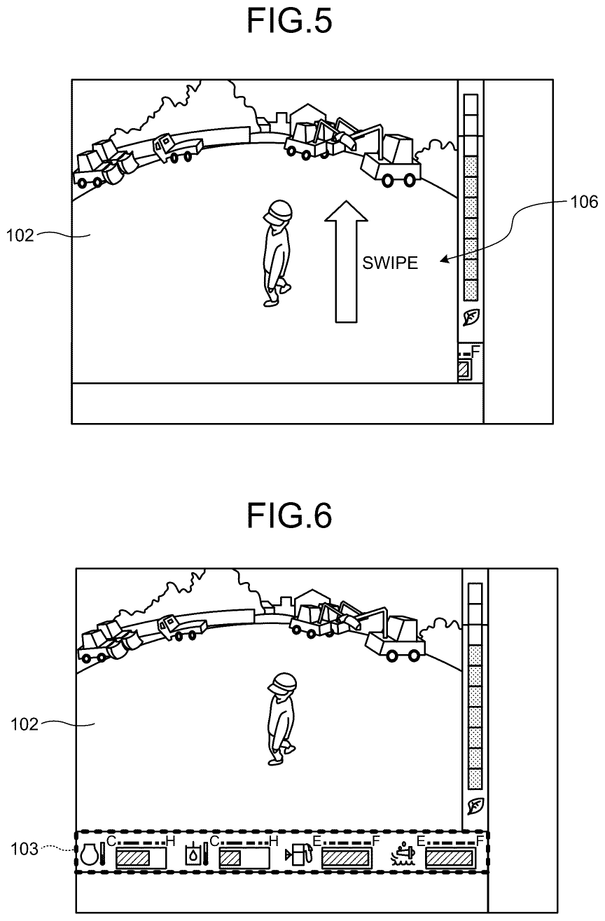

In the examples illustrated in FIGS. 2 to 4, the gauge image 103 is always displayed below the single camera image 102. As illustrated in FIGS. 5 and 6, the gauge image 103 may be displayed when the operator performs a swipe operation for displaying the gauge image 103. FIG. 5 is a view illustrating an example of a display example of the single camera image 102 displayed on the display unit. FIG. 6 is a view illustrating another example of the display example of the single camera image 102 displayed on the display unit. FIGS. 5 and 6 are views illustrating only a lower part of the display unit 11. In the example illustrated in FIG. 5, a guide image 106 for guiding the swipe operation for displaying the gauge image 103 is displayed. The guide image 106 guides the swipe operation along an arrow from the lower part to an upper part. When the operator performs the swipe operation along the guide image 106, the gauge image 103 is displayed as illustrated in FIG. 6. The guide image 106 may not be displayed.

### Display Method

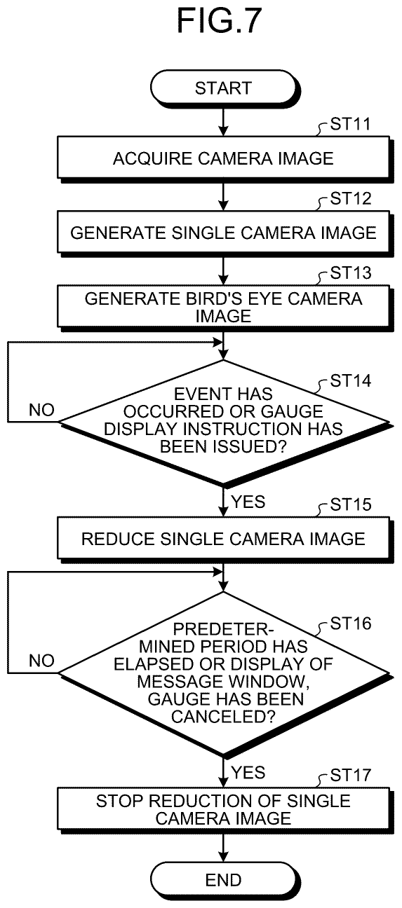

FIG. 7 is a flowchart illustrating a display method for a work machine according to the embodiment. When the excavator is keyed on, the display system 1 of the work machine is activated. When the display system 1 of the work machine is activated, photographing is always performed by the camera system 30.

The display unit controller 20 causes the interface unit 21 to acquire a camera image captured by the camera system 30 (Step ST11). The display unit controller 20 causes the interface unit 21 to acquire image data from each of the camera 31, the camera 32, the camera 33, and the camera 34 of the camera system 30.

The display unit controller 20 causes the single camera image generation unit 22 to generate the single camera image 102 (Step ST12). The display unit controller 20 causes the single camera image generation unit 22 to generate the single camera image 102 on the basis of the image data acquired by one camera of the camera system 30. The display unit controller 20 causes the image output unit 29 to cause the display unit 11 to display the generated single camera image 102.

The display unit controller 20 causes the bird's eye camera image generation unit 23 to generate the bird's eye camera image 101 (Step ST13). The display unit controller 20 causes the bird's eye camera image generation unit 23 to generate the bird's eye camera image 101 around the excavator on the basis of the image data acquired by each camera of the camera system 30. The display unit controller 20 causes the image output unit 29 to display the generated bird's eye camera image 101 on the display unit 11.

The display unit controller 20 determines whether an event has occurred or the gauge display instruction has been issued (Step ST14). When determining that an event has occurred or the gauge display instruction has been issued (Yes in Step ST14), the display unit controller 20 proceeds to Step ST15. When determining that no event has occurred and no gauge display instruction has been issued (No in Step ST14), the display unit controller 20 executes the processing of Step ST14 again.

The display unit controller 20 causes the single camera image 102 to be reduced (Step ST15). In the display unit controller 20, the image output unit 29 causes the display unit 11 to display a camera image reduced to the same shape and size as the area excluding the area in which the message window image 104 is displayed from the area in which the camera image is displayed in the state where the message window image 104 is not displayed.

The display unit controller 20 determines whether a predetermined period has elapsed, or display of the message window or the gauge has been canceled (Step ST16). The display unit controller 20 causes the image output unit 29 to determine whether or not the predetermined period has elapsed after the displaying of the message window image 104. The display unit controller 20 determines whether or not an operation unit such as an operation button or an operation menu displayed on the display unit 11 has been subjected to an operation of canceling the display of the message window image 104, an operation of canceling the display of the gauge image 103, or an operation of canceling the display of the gauge image 105. When the predetermined period has elapsed or when the display of the message window image 104, the gauge image 103, or the gauge image 105 is canceled (Yes in Step ST16), the display unit controller 20 proceeds to Step ST17. In a case where the predetermined period is yet to elapse and the display of the message window image 104, the gauge image 103, and the gauge image 105 is yet to be canceled (No in Step ST16), the display unit controller 20 executes the processing of Step ST16 again.

When the predetermined period has elapsed or when the display of the message window image 104, the gauge image 103, or the gauge image 105 is canceled (Yes in Step ST16), the display unit controller 20 causes the reduction of the single camera image 102 to be stopped (Step ST17).

By repeatedly executing the above processing during activation of the display system 1 of the work machine, an image including a camera image is displayed in the display device 10 of the excavator.

### Computer System

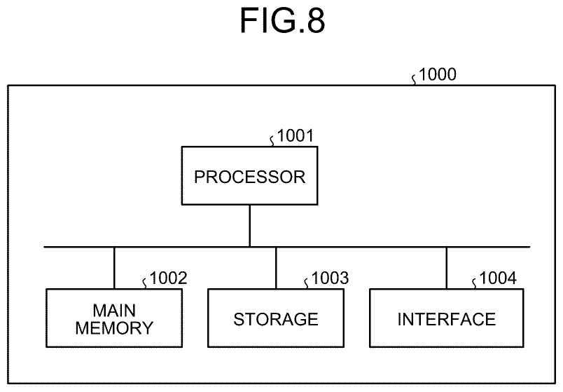

FIG. 8 is a block diagram illustrating a computer system 1000 according to the embodiment. The above-described display unit controller 20 includes the computer system 1000. The computer system 1000 has a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. The functions of the display unit controller 20 described above are stored in the storage 1003 as a computer program. The processor 1001 reads the computer program from the storage 1003, develops the computer program in the main memory 1002, and executes the above-described processing according to the computer program. Note that the computer program may be distributed to the computer system 1000 via a network.

According to the above-described embodiment, the computer program or the computer system 1000 allows execution of generating the message window image 104 to be displayed in the area of the camera image obtained by photographing around the excavator when a predetermined event related to the excavator occurs, displaying a camera image obtained by photographing around the excavator, and reducing the camera image in a case where the message window is displayed in the camera image area.

### Effects

As described above, in the embodiment, when a predetermined event related to the excavator occurs, the message window image 104 indicating a content of the event is displayed in the camera image area where the camera image is displayed, and the camera image is displayed in a reduced manner. As described above, according to the embodiment, when the message window image 104 is displayed in the camera image area around the excavator, the image can be appropriately displayed without cutting out a part of the camera image. The embodiment can transmit information to the operator appropriately.

In the embodiment, in a case where the message window image 104 is displayed in the camera image area, the reduction ratio of the camera image is decided in accordance with an area of the message window image 104.

In the embodiment, when the message window image 104 is displayed in the camera image area, the single camera image 102 is displayed in a reduced manner. In the embodiment, since the bird's eye camera image 101 is not reduced, it is possible to maintain display that makes it easy to confirm the surroundings of the excavator.

In the embodiment, in a case where the message window image 104, the gauge image 103, or the gauge image 105 is displayed in the area of the single camera image 102, the single camera image 102 is displayed in a reduced manner. According to the embodiment, in a case where the message window image 104, the gauge image 103, or the gauge image 105 is displayed in the area of the single camera image 102, it is possible to appropriately display an image without cutting out a part of the bird's eye camera image 101 and the single camera image 102.

In the embodiment, after a predetermined period elapses after the displaying of the message window image 104, the display of the message window image 104 is stopped, and the reduction of the single camera image 102 is released. According to the embodiment, when a necessity of displaying the message window image 104 is reduced, the display of the message window image 104 can be stopped to return the single camera image 102 to an original size. According to the embodiment, reduction of the single camera image 102 and release of the reduction can be appropriately controlled.

In the embodiment, in a case where the message window image 104 has the content indicating an abnormality of the excavator, when the abnormality is resolved, the display of the message window image 104 is stopped and the reduction of the single camera image 102 is released. According to the embodiment, when the abnormality is resolved, it is possible to stop the display of the message window image 104 and return the single camera image 102 to the original size. According to the embodiment, reduction of the single camera image 102 and release of the reduction can be appropriately controlled.

In the above-described embodiment, the excavator may be a mining excavator for use in a mine or the like, or may be an excavator for use at a construction site. Furthermore, the present invention can be applied to a display system for a dump truck, a wheel loader, or other work machine.

### Modified Example

Whether or not to reduce the single camera image 102 may be changed depending on whether or not an object including a person or a work machine such as other excavator present around the excavator is displayed in the camera image. The display unit controller 20 further includes a determination unit.

The determination unit determines, from the camera image, whether or not there is an object including a person or a work machine such as other excavator around the excavator. The determination unit determines whether or not an object is displayed in the area where the message window, the gauge image 103, or the gauge image 105 is displayed in a normal state in which the message window, the gauge image 103, or the gauge image 105 is displayed as it is on the camera image in a superimposed manner. More specifically, the determination unit determines whether or not the object is present around the excavator on the basis of the image data acquired by the interface unit 21. The determination unit performs image processing of the image data acquired by the interface unit 21 to determine presence or absence of a person around the excavator. The image processing includes processing of extracting a feature value of the object from the image data. The determination unit collates the feature value extracted from the image data with a feature value of the object stored in a feature value storage unit, and determines whether an object is present or not in the area where the message window, the gauge image 103, or the gauge image 105 is displayed.

In a case where the message window, the gauge image 103, or the gauge image 105 is displayed in the area of the single camera image 102, when it is determined that an object is displayed in the area where the message window, the gauge image 103, or the gauge image 105 is displayed, the display unit controller 20 causes the single camera image 102 to be displayed in a reduced manner. When it is determined that no object is displayed in the area where the message window, the gauge image 103, or the gauge image 105 is displayed, the display unit controller 20 causes the single camera image 102 to maintain its size, and causes the message window, the gauge image 103, or the gauge image 105 to be displayed in the area of the single camera image 102 in a superimposed manner.

### Effects

According to the modified example, in a case where the message window image 104, the gauge image 103, or the gauge image 105 is displayed in the area of the single camera image 102, when it is determined that an object is displayed in the area where the message window image 104, the gauge image 103, or the gauge image 105 is displayed, the single camera image 102 is displayed in a reduced manner. According to the modification, the single camera image 102 can be appropriately reduced.

### Modified Example

In the above-described embodiment, the display unit controller 20 may cause the message window image 104, the gauge image 103, or the gauge image 105 to be displayed in the bird's eye camera image 101, and cause the bird's eye camera image 101 to be displayed in a reduced manner. In this case, the message window image 104, the gauge image 103, or the gauge image 105 can be displayed in the camera image area without reducing the single camera image 102.

### REFERENCE SIGNS LIST

1 DISPLAY SYSTEM
10 DISPLAY DEVICE
11 DISPLAY UNIT
20 DISPLAY UNIT CONTROLLER (DISPLAY CONTROL UNIT)
21 INTERFACE UNIT
22 SINGLE CAMERA IMAGE GENERATION UNIT
23 BIRD′S EYE CAMERA IMAGE GENERATION UNIT
24 MESSAGE WINDOW IMAGE GENERATION UNIT
25 GAUGE IMAGE GENERATION UNIT
29 IMAGE OUTPUT UNIT
30 CAMERA SYSTEM
31 CAMERA
32 CAMERA
33 CAMERA
34 CAMERA
101 BIRD'S EYE CAMERA IMAGE
102 SINGLE CAMERA IMAGE
103 GAUGE IMAGE
104 MESSAGE WINDOW IMAGE
105 GAUGE IMAGE

1. A display system for a work machine, comprising:
a display unit that displays a camera image obtained by photographing around a work machine;
a display control unit that causes a display unit to display the camera image; and
a message window image generation unit that when a predetermined event related to the work machine occurs, generates a message window image indicating a content of the event,
wherein
when a predetermined event related to the work machine occurs, the display control unit causes a message window image indicating a content of the event to be displayed in a camera image area for displaying the camera image, and causes the camera image to be displayed in a reduced manner.

2. The display system for a work machine according to claim 1, wherein
the display control unit decides a reduction ratio of the camera image in accordance with an area of the message window image displayed.

3. The display system for a work machine according to claim 1, wherein
the camera image is a bird's eye camera image and a single camera image around the work machine, and
when the message window image is displayed in the camera image area, the display control unit causes the single camera image to be displayed in a reduced manner.

4. The display system for a work machine according to claim 3, further comprising:
a gauge image generation unit that generates a gauge image indicating a state of the work machine in a single camera image area displaying the single camera image according to an instruction of an operator,
wherein
when the message window image or the gauge image is displayed in the single camera image area, the display control unit causes the single camera image to be displayed in a reduced manner.

5. The display system for a work machine according to claim 4, further comprising:
a determination unit that determines, from the camera image, whether or not there is an object including a person or other work machine around the work machine;
wherein
the determination unit determines whether or not the object is displayed in an area where the message window image or the gauge image is displayed, and
in a case where the message window image or the gauge image is displayed in the single camera image area, when it is determined that the object is displayed in the area where the message window image or the gauge image is displayed, the display control unit causes the single camera image to be displayed in a reduced manner.

6. The display system for a work machine according to claim 3, wherein
when the message window image has a content indicating guidance to an operator, the display control unit stops the display of the message window image and releases the reduction of the single camera image after a predetermined period elapses after the displaying of the message window image.

7. The display system for a work machine according to claim 3, wherein
the display control unit stops the display of the message window image and releases the reduction of the single camera image in a case where the message window image has a content indicating an abnormality of the work machine, when the abnormality of the work machine is resolved.

8. A work machine comprising:
the display system for a work machine according to claim 1; and
working equipment.

9. A display method for a work machine comprising:
when a predetermined event related to a work machine occurs, generating a message window image to be displayed in a camera image area displaying a camera image obtained by photographing around the work machine; and
causing the camera image to be displayed, and reducing the camera image when the message window image is displayed in the camera image area.
